(19) United States
(12) Patent Application Publication
(10) Pub. No.: US 2008/0202354 A1
(43) Pub. Date: Aug. 28, 2008

(54) Cooking apparatus and method of controlling the same

(75) Inventors: Tae Uk Lee, Suwon-si (KR); Dae Sung Han, Hwaseong-si (KR); Yong Hyun Kwon, Suwon-si (KR); Seok Weon Hong, Yongin-si (KR); Pung Yeun Cho, Suwon-si (KR); Han Seong Kang, Hwasung-si (KR); Sung Soo Park, Hwaseong-si (KR); Han Jun Sung, Yongin-si (KR); Sung Kwang Kim, Ansan-si (KR); Hyung Jin Kim, Pohang-si (KR); Tae Hun Kim, Seoul (KR); Min Jae Kang, Cheongju-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., SUWON-SI (KR)

(21) Appl. No.: 12/007,690

(22) Filed: Jan. 14, 2008

(30) Foreign Application Priority Data
Feb. 26, 2007 (KR) 2007-19121

(51) Int. Cl. B60H 3/00

(52) U.S. Cl. 99/476

(57) ABSTRACT

A cooking apparatus and a method of controlling the same utilize the operations of measuring a temperature of a cooking chamber, and periodically turning on and off a convection fan, which circulates air in the cooking chamber, when the temperature of the cooking chamber reaches a target temperature.

### CROSS-REFERENCE TO RELATED APPLICATION

This application claims the benefit of Korean Patent Application No. 2007-0019121, filed on Feb. 26, 2007, in the Korean Intellectual Property Office, the disclosure of which is incorporated herein by reference.

### BACKGROUND

1. Field

The present invention relates to a cooking apparatus and a method of controlling the same. More particularly, the present invention relates to a cooking apparatus and a method of controlling the same, to remove a vortex formed in a cooking chamber when cooking foodstuff in a convection cooking mode so that the temperature is uniformly distributed in the cooking chamber.

2. Description of the Related Art

In general, a conventional cooking apparatus using convection phenomenon, as disclosed in Korean Unexamined Patent Publication No. 10-2006-0013872 (Oven Sector Structure of Electrical Oven), comprises a heater that receives electricity to discharge heat, an oven cavity in which food is cooked by the heat discharged from the heater, a convection fan provided at the rear of the oven cavity to circulate air inside the oven cavity, a convection orifice guiding the air circulated by rotation of the convection fan, and a plurality of trays provided in a cooking chamber to place the food thereon.

In such a conventional cooking apparatus, when a user places the food in the oven cavity and inputs a cooking order, the heater heats the oven cavity and the convection fan is continuously operated, so that high temperature air circulates in the cooking chamber. In this process, the food continuously makes contact with the high temperature air to receive the heat, and consequently, the food is cooked by the heat.

However, in such a conventional cooking apparatus, since the convection fan is continuously operated together with the heater during the cooking process, the air circulates in the same pattern, and the air collides with the tray or the food while the air is being circulated, so that vortexes are formed in the cooking chamber. When the vortex is formed in the cooking chamber, the temperature of a region where the vortex occurs is different from that of a region where the air is readily circulated. As a result, the temperature distribution in the cooking chamber is non-uniform. If the temperature distribution in the cooking chamber is non-uniform, some portions of the food are overcooked, and other portions are insufficiently cooked, thereby deteriorating the cooking quality.

To solve such a problem, the convection fan is changed from a centrifugal fan to an axial fan in the above-mentioned Korean Unexamined Patent Publication No. 10-2006-0013872. However, if the axial fan is continuously operated, the vortex is formed at a specific region in the cooking chamber, so the temperature distribution in the cooking chamber is non-uniform.

### SUMMARY

In an aspect of the present invention to provide a cooking apparatus and a method of controlling the same, remove a vortex formed in a cooking chamber to uniformly distribute the temperature in the cooking chamber.

The foregoing and/or other aspects of the present invention are achieved by a method to control a cooking apparatus comprising the operations of measuring a temperature of a cooking chamber, and periodically turning on and off a convection fan, which circulates air in the cooking chamber, when the temperature of the cooking chamber reaches a target temperature.

According to an aspect of the present invention, the method further comprises an operation of continuously turning on the convection fan when the temperature of the cooking chamber is lower than the target temperature.

Further, according to an aspect of the present invention, a cooking apparatus comprises at least one heater heating a cooking chamber, a convection fan circulating air in the cooking chamber, and a microcomputer periodically turning on and off the convection fan when a temperature of the cooking chamber reaches a target temperature due to an operation of at least one heater.

According to an aspect of the present invention, the cooking apparatus further comprises a temperature sensor that measures the temperature of the cooking chamber.

According to an aspect of the present invention, the microcomputer continuously turns on the convection fan until the temperature of the cooking chamber reaches the target temperature.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

These and/or other aspects and advantages of the invention will become apparent and more readily appreciated from the following description of the embodiments, taken in conjunction with the accompanying drawings of which:

FIG. 1 is a front view illustrating a cooking apparatus according to an embodiment of the present invention;

FIG. 2 is a side sectional view illustrating a cooking apparatus according to an embodiment of the present invention;

FIG. 3 is a block diagram illustrating a cooking apparatus according to an embodiment of the present invention;

FIG. 4 is a flowchart illustrating a method of controlling a cooking apparatus according to an embodiment of the present invention; and

FIG. 5 is a graph illustrating an on/off state of a convection fan when controlling a cooking apparatus using the control method shown in FIG. 4.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

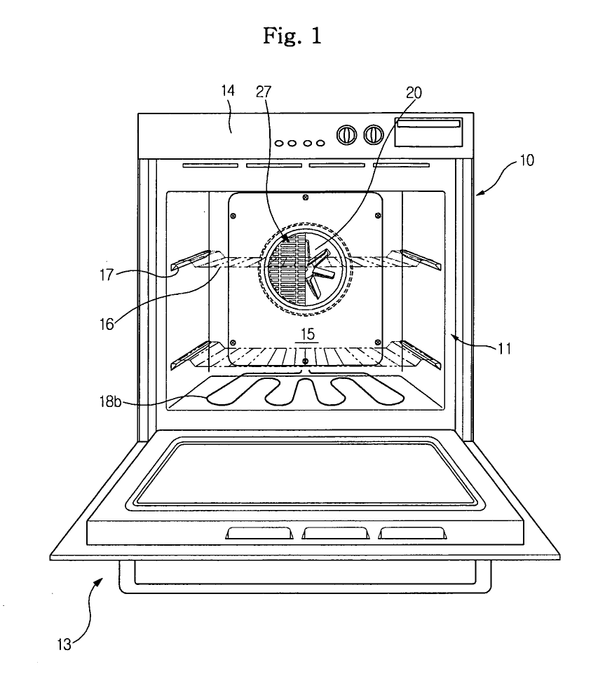

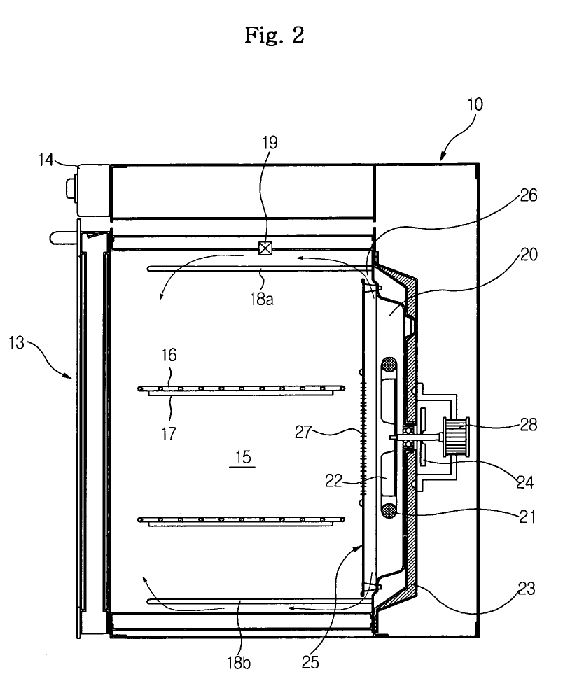

As shown in FIGS. 1 and 2, a cooking apparatus according to an embodiment of the present invention comprises a box-shaped outer case 10 having an opened front, a box-shaped inner case 11 formed in the outer case 10, and a door 13 hinged to a lower part of the inner case 11 to open and close the opened front of the inner case 11. The outer case 10 comprises a control input unit 14 at the top thereof to allow the user to input the cooking type, the cooking time, and the like.

The inner case 11 is disposed in the outer case 10 while being spaced apart from the outer case 10 by a predetermined distance, and a cooking chamber 15 is formed in the inner case 11. The cooking chamber 15 comprises a plurality of guide rails 17 at the inner sidewalls thereof such that trays 16, whereon a food is placed, can be detachably mounted on the guide rails 17. A blowing chamber 20 is recessed backwards at the inner rear wall of the cooking chamber 15. A top heater 18A and a bottom heater 18B are provided at the top and bottom of the cooking chamber 15, respectively. The cooking chamber 15 comprises a cooking chamber temperature sensor 19 at the top surface thereof to measure the temperature of the cooking chamber 15.

The blowing chamber 20 comprises a convection heater 21 having a ring shape, and a convection fan 22 installed in the inner circumference of the convection heater 21 so that heat generated from the various heaters 18A, 18B and 21 circulates in the cooking chamber 15. In addition, an insulating wall 23 is formed at the rear of the blowing chamber 20. Moreover, a fan motor 28 operating the convection fan 22, and a cooling fan 24 cooling the fan motor 28 and other electric/electronic parts are interposed between the insulating wall 23 and the outer case 10.

The blowing chamber 20 comprises a cover 25 at the front thereof. The outer circumference of the cover 25 is separated from an entrance of the blowing chamber 20, thereby forming an exhaust port 26. In addition, the cover 25 has an air suction port 27 at the center thereof. According to this construction, when the convection fan 22 rotates, air in the cooking chamber 15 is introduced into the blowing chamber 20 through the air suction port 27 located at the center of the cover 25, so that the air is blown in the outer circumferential direction of the convection fan 22. Accordingly, the air introduced into the blowing chamber 20 from the cooking chamber 15 is heated by the convection heater 21 located at the outer circumference of the convection fan 22. Then, the air passes through the exhaust port 26 to return to the cooking chamber 15 again. In this manner, when the heated air circulates in the cooking chamber 15, the food is heated by the heated air, and thus the food is cooked.

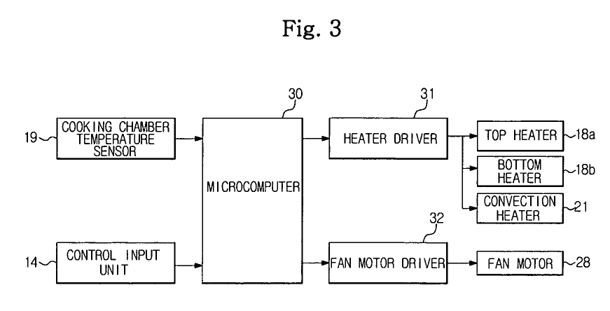

As shown in FIG. 3, the cooking apparatus according to an embodiment of the present invention further comprises a heater driver 31 to drive the various heaters 18A, 18B and 21, a fan motor driver 32 to drive the fan motor 28, and a microcomputer 30 to control the operation of the cooking apparatus, in addition to the components shown in FIGS. 1 and 2.

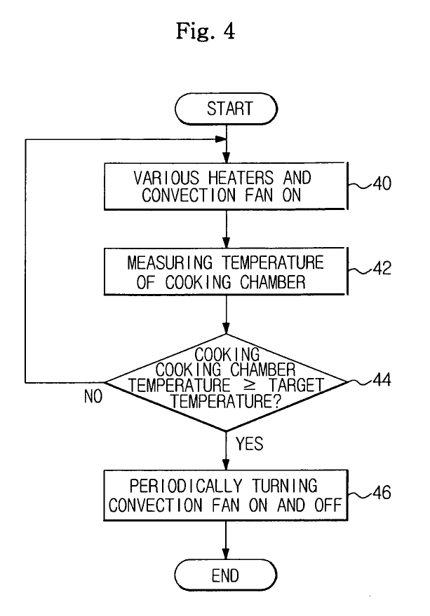

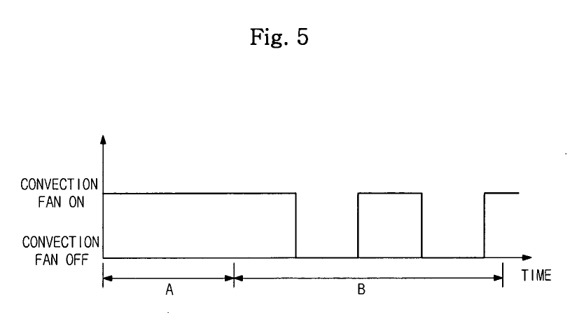

Hereinafter, a method of controlling the cooking apparatus according to an embodiment of the present invention will be described with reference to FIGS. 4 and 5. After placing the food on the tray 16 and mounting the tray 16 on the cooking chamber 15, the user controls the control input unit 14 to input the cooking commands such as the cooking type, the cooking time, and the like. Then, the microcomputer 30 turns on the top heater 18A, the bottom heater 18B and the convection heater 21, and also turns on the convection fan 22 so that the heated air is circulated in the cooking chamber 15 (40).

In addition, the cooking chamber temperature sensor 19 measures the temperature of the cooking chamber 15, and transmits the measured temperature to the microcomputer 30 (42). Upon receiving the measured temperature of the cooking chamber temperature sensor 19, the microcomputer 30 decides whether the temperature of the cooking chamber 15 has reached a target temperature (44).

Here, the target temperature is a desirable cooking temperature obtained based on the type of food, etc. The user may manually set the target temperature, or if the user selects the food type, the microcomputer 30 can automatically set the target temperature according to the food type. To this end, the desirable cooking temperature according to the food type must be previously stored in the microcomputer 30.

If the temperature of the cooking chamber 15 has not yet reached the target temperature, the microcomputer 30 repeats the operation (40) of turning on the various heaters 18A, 18B and 21 and the convection fan 22. Meanwhile, if the temperature of the cooking chamber 15 has reached the target temperature, the microcomputer 30 controls the convection fan 22 such that the convection fan 22 is periodically turned on and off (46). As shown in FIG. 5 (in which, the x-axis represents time and the y-axis represents an on/off state of the convection fan), when performing the cooking operation according to the present invention, the convection fan 22 is continuously turned on until the temperature of the cooking chamber 15 reaches the target temperature (A period), and the convection fan 22 is repeatedly turned on and off for a predetermined time when the temperature of the cooking chamber 15 reaches the target temperature (B period). Preferably, the on/off time is set by the manufacturer of the cooking apparatus through various experiments, and the on/off period may be variously set according to the type of foods.

In this manner, if the convection fan 22 is periodically turned on and off, the vortex, which occurs in the cooking chamber 15 during the operation of the convection fan 22, is removed. Accordingly, the differential temperature between a region where the vortex occurs and a region where the air is readily circulated is greatly reduced. As a result, the temperature distribution in the cooking chamber becomes uniform.

As described above, the present invention uniformly distributes the heated air, causing the temperature throughout the cooking chamber to be uniform when cooking foodstuff in a convection cooking mode, thereby improving the cooking quality.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling a cooking apparatus, the method comprising:
measuring a temperature of a cooking chamber; and
periodically turning on and off a convection fan, which circulates air in the cooking chamber, when the temperature of the cooking chamber reaches a target temperature.

2. The method of claim 1, further comprising continuously turning on the convection fan when the temperature of the cooking chamber is lower than the target temperature.

3. A cooking apparatus comprising:
at least one heater heating a cooking chamber;
a convection fan circulating air in the cooking chamber; and
a microcomputer periodically turning on and off the convection fan when a temperature of the cooking chamber reaches a target temperature due to an operation of the at least one heater.

4. The cooking apparatus of claim 3, further comprising a cooking chamber temperature sensor that measures the temperature of the cooking chamber.

5. The cooking apparatus of claim 3, wherein the microcomputer turns on the convection fan continuously until the temperature of the cooking chamber reaches the target temperature.

6. A cooking apparatus comprising:
a control input unit;
at least one heater in a cooking chamber;
a blowing chamber attached to the cooking chamber, wherein the blowing chamber comprises a convection heater and a convection fan to suck air into the blowing chamber and blow air in a direction of an outer circumference of the convection fan to be heated by a convection heater;
a temperature sensor in the cooking chamber to measure a temperature of air in the cooking chamber, and
a microcomputer, coupled to the control input unit, the at least one heater, the convection heater, the convection fan and the temperature sensor, to periodically turn on and off the convection fan when a temperature of the cooking chamber reaches a target temperature.

7. A cooking apparatus, comprising:
at least one heater heating a cooking chamber;
a temperature sensor that measures a temperature of the cooking chamber;
a blowing chamber adjacent to the cooking chamber, having a convection fan sucking air from the cooking chamber, moving the air past a convection heater to heat the air sucked from the cooking chamber, and returning the air to the cooking chamber; and
a microcomputer periodically turning on and off the convection fan when a temperature of the cooking chamber reaches a target temperature.
